(19) United States
(12) Patent Application Publication
(10) Pub. No.: US 2020/0287488 A1
(43) Pub. Date: Sep. 10, 2020

(54) METHOD FOR OPERATING A DOUBLE-FED ASYNCHRONOUS MACHINE

(71) Applicant: Siemens Aktiengesellschaft, 80333 München (DE)

(72) Inventor: ROLAND ZEICHFÜSSL, Ruhstorf a. d. Rott (DE)

(73) Assignee: Siemens Aktiengesellschaft, 80333 München (DE)

(21) Appl. No.: 16/759,181

(22) PCT Filed: Oct. 19, 2018
(86) PCT No.: PCT/EP2018/078692

§ 371 Date: Apr. 24, 2020

(30) Foreign Application Priority Data
Oct. 25, 2017 (EP) 17198315.8

(51) Int. Cl. H02P 9/00; H02P 1/26

(52) U.S. Cl. CPC H02P 9/007; H02P 1/26

(57) ABSTRACT

In a method for operating a double-fed asynchronous machine, an exciter winding of the rotor is excited by adjusting an amplitude or a frequency of a voltage or current independently of armature values of the stator to attain a predetermined phase position and amplitude in the stator. While the stator is disconnected from an electrical grid, the rotation speed of the rotor is increased during startup and the amplitude of the voltage and/or of the current flow is adjusted to less than a start-up limit value, while the frequency of the voltage and/or of the current flow is adjusted to a grid frequency. The winding arrangement is then connected to the electrical grid, and the amplitude of the voltage and/or of the current flow is adjusted to an operating value which is greater than the start-up limit value by a predetermined amount.

The invention relates to a method for operating a double-fed asynchronous machine.

A double-fed asynchronous machine has a stator and a rotor. The stator comprises a winding arrangement that is preferably connected, during operation of the asynchronous machine, to an electrical grid, for example the 50 Hz interconnected grid. The rotor has an exciter winding, which is connected to a current converter, in particular an inverter. Via the inverter the exciter winding can be connected indirectly to the electrical grid. Via the current converter, depending on the operating mode of the asynchronous machine, electrical energy can be fed from the grid into the rotor or from the rotor into the grid. In this case the speed of rotation of the rotor can lie below the synchronous speed (subsynchronous operation) or above the synchronous speed (supersynchronous operation).

The asynchronous machine is excited via the exciter winding. In this case the electrical power taken up or emitted by the stator (active power and reactive power) is regulated via the excitation of the asynchronous machine or of the rotor. To excite the rotor or the asynchronous machine an electrical voltage is applied via the current converter to the exciter winding and/or an electrical current is injected into the exciter winding. To do this the current converter has a control unit, which measures the speed and angle via a rotary position transducer and amplitude and phase position of the voltage and/or of the current in the winding arrangement via electrical measurement converters. In other words the excitation of the rotor will be regulated depending on the speed and the angle of the rotor and also depending on the amplitude and phase position of the voltage and/or of the current in the winding arrangement.

Moreover regulation methods without rotary position transducers are known, in which the angle of the rotor is determined via the amplitudes and phase positions of the currents and voltages in the stator and in the rotor. In summary this always involves a closed-loop regulation circuit for regulating the rotor voltage of the rotor current.

EP 2 001 120 A2 deals with a control device for a double-fed asynchronous generator. The control device has an inverter circuit with a number of levels, which control the double-fed asynchronous generator through failure modes and can recognize faulty island modes. The inverter circuit is supplied with electrical energy on the grid side.

EP 2 200 169 A2 describes the starting up of an asynchronous machine while said machine is disconnected from an energy supply grid. When a speed of for example 350 revolutions per minute is reached the asynchronous machine is demagnetized and thereafter the rotor current is switched off. This ensures that a short-circuit switch can be opened almost without any current. The asynchronous machine is then magnetized again and synchronized with the energy supply. The asynchronous machine is henceforth operated in its normal operation. When the short-circuit switch is designed as a power switch or as a load isolator a prior demagnetization is not required.

The disadvantage of the prior art is that the converter, in particular the inverter, must be specifically designed for the asynchronous machine.

The object of the present invention is to make possible an improved control of the excitation of the asynchronous machine.

Not part of the claimed invention is a double-fed asynchronous machine with
a rotor that has an exciter winding,
a stator that comprises a winding arrangement,
an electrical exciter unit for exciting the asynchronous machine via the exciter winding, and
a control unit for controlling the exciter unit by adjusting at least one electrical variable for the excitation.

To make easier control of the excitation of the asynchronous machine possible there is provision for the control unit not to have any signaling or electrical connection to the stator that goes beyond purely supplying energy to the control unit, so that the at least one electrical variable is able to be adjusted by the control unit independently of electrical stator variables of the winding arrangement.

For example the exciter unit involves a current source or a voltage source. The winding arrangement of the stator is in particular a three-phase arrangement. Then, when the asynchronous machine is operating, a three-phase alternating current flows through the winding arrangement as the stator current. The stator current refers to the overall current that flows through the winding arrangement. A stator voltage refers to a voltage that is applied to the winding arrangement. In particular this involves a three-phase alternating voltage. The stator voltage, the stator current and its phase position, for example in relation to one another and/or related to an electrical grid, are examples of stator variables.

The exciter winding is in particular a three-phase arrangement. The exciter unit can accordingly be configured to inject a current flow (rotor current) into the exciter winding and/or to apply a voltage (rotor voltage) to the exciter winding. This enables the excitation of the asynchronous machine to be achieved. The exciter unit can be embodied, depending on the operating point of the asynchronous machine, to feed electrical power into the exciter winding or to take it from the exciter winding. The control unit can be configured to influence or to control this current flow and/or this voltage by adjusting the at least one electrical variable. In other words the control unit can be configured to control the excitation of the asynchronous machine by specifying the electrical variable, wherein the rotor current and/or the rotor voltage are influenced or controlled in their turn by means of the electrical variable. The at least one electrical variable relates to amplitude and/or frequency of the rotor current and/or of the rotor voltage for example.

The current flow or the voltage in the exciter winding can be adjusted by the control unit in such a way that a pre-specified stator current is produced in the winding arrangement in relation to amplitude and/or phase position. In other words the control unit can be embodied to control the excitation so that a predetermined amplitude and/or phase position is produced for the stator current. Since the control unit does not have a signaling or electrical connection to the stator, there is no feedback here. Values related to the rotor, for example the rotor voltage and/or the rotor current, are able to be adjusted by the control unit by adjusting the at least one electrical variable independently of the stator or without interaction with the stator. For example the control unit is configured to adjust a pre-specified value for the at least one electrical variable. Through this form of control of excitation of the asynchronous machine demands on the exciter unit and also the measuring units are especially low.

The control unit and the exciter unit can be able to be connected to an electrical grid, in particular the 50 Hz interconnected grid. In this case the exciter unit can be configured, on injection of the rotor current or on application of the rotor voltage to the exciter winding, to feed electrical energy into the electrical grid from the exciter winding or to feed electrical energy from the electrical grid into the exciter winding. The stator or the winding arrangement can be able to be directly connected to the electrical grid.

One form of embodiment makes provision for the control unit and the exciter unit to be able to be connected to the electrical grid for exclusively supplying them with electrical energy and for the winding arrangement likewise to be able to be connected to the electrical grid, wherein the control unit and the exciter unit are able to be connected to the stator exclusively in this way for signaling or electrically. In other words, when the asynchronous machine is operating on the electrical grid, the exciter unit and the control unit are connected to the stator or to the winding arrangement exclusively via the electrical grid. Instead the control unit can be embodied to predetermine the electrical variable or the rotor current and/or the rotor voltage at least partly based on a frequency of the electrical grid.

The exciter unit is configured in particular to connect the exciter winding to the electrical grid. In this case the connection between exciter winding and electrical grid can be switchable by the exciter unit. For example the exciter unit has at least one switching element for through-connecting a power supply voltage from the electrical grid to the exciter winding. The at least one switching element can be controlled or switched by the control unit. The rotor current or the rotor voltage is able to be controlled in the exciter winding by suitable switching of the at least one switching element.

The control unit is embodied in particular to control the exciter unit in accordance with an open regulation circuit. In other words, because of the absence of a connection between the control unit and the stator, there is no feedback on the basis of stator variables. In particular the control unit is not embodied to compare the stator variables with a required value. On the contrary the control unit is preferably embodied to adjust or to control the electrical variable or the rotor current and/or the rotor voltage free from the stator variables.

One development makes provision for the control unit to comprise a memory unit, in which a characteristic field for adjusting the at least one electrical variable can be stored, and for the control unit to be embodied to control the exciter unit on the basis of the characteristic field. For example the at least one electrical variable for one or more operating points of the asynchronous machine is permanently predetermined by the characteristic field. In this case the control unit can be embodied to adjust the exciter unit by adjusting the at least one electrical variable to at least one predetermined characteristic field value that is read out of the characteristic field. Through the characteristic field a suitable excitation can be predetermined for many operating points. In particular a comprehensive control of the excitation is possible through the characteristic field without the need for feedback. The characteristic field can be established or recorded in a test mode of the asynchronous machine for example.

One development makes provision for a rotation angle transducer or a rotation speed transducer to be mounted on a shaft of the asynchronous machine. This shaft can be connected mechanically to the rotor. In particular the shaft is arranged on the rotor and rotates uniformly with the latter. The control unit can be configured to use its signal or its signals to deduce the angle and/or the direction of rotation and frequency of the stator rotating field from the angle of rotation and/or the direction of rotation and speed of rotation of the rotor together with the angle and/or the direction of rotation and frequency of the rotor rotating field. This enables the frequency of the electrical grid that feeds the stator to be determined and monitored without measuring stator variables directly.

If the frequency of the electrical grid that feeds the stator is known from another source, e.g. during operation on the 50 Hz interconnected grid or through a control or regulation of the electrical grid independent of the apparatus described here, it is further possible to compare the frequency of the electrical grid with the difference between the speed and the frequency of the rotor rotating field and thus to monitor that the stator rotating field and the rotor rotating field are running synchronously (synchronism) and the asynchronous machine is not pulling out of step. In particular in this case the known frequency of the electrical grid is able to be predetermined to the control unit. The control unit can be configured to carry out the aforementioned comparison and/or monitoring. In this case too it is not necessary for the stator current or the stator voltage to be measured by the control unit.

One development makes provision for the exciter unit to be designed as a current converter. In particular the exciter unit can be designed as an inverter. The current converter can be embodied to adjust phase position, frequency and/or amplitude of the rotor current in relation to the grid voltage. In other words the current converter can adjust the grid voltage in such a way that phase, frequency and/or amplitude of the rotor current and/or of the rotor voltage correspond to the at least one electrical variable adjusted by the control unit. The current converter is a simple and effective option to excite the rotor controllably via the electrical grid.

One development makes provision for the exciter unit to be embodied universally for providing or shaping electrical energy independently of the asynchronous machine. In other words the exciter unit is preferably not embodied specifically for the purpose of exciting the asynchronous machine, but has a universal application, for example as a current converter or inverter. In particular the option of using a universally applicable current converter as the exciter unit produces an especially simple structure of the asynchronous machine.

The asynchronous machine can be connectable to a load or to a drive. For example a shaft of the asynchronous machine, which is part of the rotor, can have a coupling element for coupling the shaft to the load or to the drive. The load involves a mechanical load for example, which is able to be driven by the asynchronous machine, or a further electrical machine, a so-called load machine. In particular the load is able to be operated by the asynchronous machine in a motor mode of the asynchronous machine. The asynchronous machine can be embodied in its motor mode to transmit a torque to the load. The drive for example involves an electrical machine, a turbine, in a power plant for example, or a wind turbine of a wind turbine system. The asynchronous machine can be embodied to receive a torque from the drive. The asynchronous machine is able to be set into rotation by the drive. In particular the asynchronous machine is able to be driven by the drive in a generator mode of the asynchronous machine.

A torsional vibration damper can be provided on the shaft of the asynchronous machine. The torsional vibration damper can contribute a pre-specified portion to the moment of inertia of the rotor. For example the torsional vibration damper has a portion of 10% of the moment of inertia of the rotor %. The torsional vibration damper in particular involves an additional moment of inertia supported sprung on the shaft, Vibrations of the shaft can be minimized through the damping of the spring element.

As an alternative or in addition a damping can be achieved for example by a fan wheel being mounted on the shaft.

The torsional vibration damper, the fan wheel and the load, in particular the load machine, represent examples of how vibrations of the asynchronous machine can be reduced during operation. By connecting the asynchronous machine to the load, it is possible to reduce or compensate for vibrations that arise through the structure of the exciter unit and the control unit described. Likewise these vibrations can be reduced or compensated for through the use of the torsional vibration damper. In a conventional asynchronous machine, of which the excitation is able to be regulated by feedback in a closed loop regulation circuit, such measures are not necessary.

Claimed as the invention within the framework of the present application is a method for operating a double-fed asynchronous machine. The method is based on the following steps:
excitation of an exciter winding of a rotor of the asynchronous machine by an exciter unit, and
control of the exciter unit by adjusting at least one electrical variable for the excitation.

There is provision that during the control, the at least one electrical variable is adjusted independently of armature variables of a winding arrangement of a stator of the asynchronous machine. In other words the electrical variable can be adjusted free of feedback. In this case the electrical variable is adjusted solely with reference to rotor-related variables for example.

The inventive method is suitable for operating a double-fed asynchronous machine of the type described here. The inventive method and the asynchronous machine thus relate to one another. For this reason features of the inventive method also develop the asynchronous machine and vice versa. Therefore the features already described in the context of the asynchronous machine are not described once again.

In the inventive method there is provision for the electrical variable for the excitation to be adjusted in accordance with an open regulation circuit. In other words the excitation of the asynchronous machine or of the rotor can be controlled in accordance with the open regulation circuit. This means that a feedback on the basis of the stator variables is dispensed with. In particular the electrical variable is predetermined with reference to a characteristic field of the.

Moreover there is provision for amplitude and frequency of a voltage (rotor voltage) or of a current flow (rotor current) to be adjusted as the at least one electrical variable for the excitation, so that a predetermined phase position and a predetermined amplitude is achieved in the stator. In particular a predetermined phase position and a predetermined amplitude of the stator current or of the stator voltage are achieved by this in the winding arrangement of the stator. In this case the phase position and/or the amplitude of the stator current is calculated for example, since the feedback of the stator variables, i.e. stator current or stator voltage, is dispensed with for example. For example values for the amplitude and/or the frequency of the rotor voltage are stored in the characteristic field, for which the predetermined phase position and the predetermined amplitude of the stator current or of the stator voltage is produced. In this way the excitation of the rotor can be controlled in an especially simple way.

During a startup process of the asynchronous machine there is provision for the chosen amplitude of the voltage (stator voltage) and/or of the current flow (rotor current) to be less than a pre-specified start-up limit value and the for the frequency of the voltage (rotor voltage) and/or of the current flow (rotor current) to be able to be adjusted to a grid frequency of an electrical grid to which the winding arrangement of the stator is able to be connected. During the startup process and/or in the operation of the asynchronous machine the stator or the winding arrangement of the stator is in particular connected to the electrical grid, Preferably the exciter winding is moreover connected to the electrical grid via the exciter unit. The exciter unit preferably involves a current converter, especially an inverter. Thus for example the grid frequency of the electrical grid can be measured at the rotor or at the exciter unit. The startup limit value can be defined as a fixed value, by the characteristic field for example. As part of the start-up process the winding arrangement of the stator can subsequently be connected to the electrical grid or switched on. In this case the phase position of rotor and stator are adjusted to one another automatically. When the winding arrangement is connected to the electrical grid compensating currents can flow. Moreover a torque can be generated at the rotor, through which the phase position or rotor and stator can be adjusted to one another by adjusting the rotor. The fact that the amplitude of the rotor voltage and/or of the rotor current is chosen as a smaller value that the start-up limit value enables the compensation currents to be kept lower than a pre-specified limit value. This is needed in particular since, as a result of the absence of feedback or as a result of the open control (in accordance with the open regulation circuit), a unique phase position of rotor and stator is not able to be predetermined or adjusted. Through the start-up process described however the phase position automatically adjusts itself to an ongoing value.

After the connection or switching-on of the winding arrangement to/at the electrical grid there is provision for the amplitude of the voltage and/or of the current flow to be adjusted to a predetermined operating value. The pre-specified operating value in this case is in particular larger by a pre-specified amount than the start-up limit value. The operating value can be adapted in this case to a rated power or to a torque of the asynchronous machine, Using this as a starting point, the pre-specified start-up limit value can be predetermined to be smaller by a pre-specified amount.

The start-up process can also occur when the asynchronous machine is already rotating. This is the case for example when the asynchronous machine is operated as a generator and is brought up to a specific speed by the drive machine. So that the compensation currents and the torques are as low as possible during the compensation process, the adjustment and frequency of the rotor rotating field can be predetermined so that the rotational frequency of the rotating field is produced together with speed of rotation of the rotor at approximately the rotation frequency of the stator rotating field. The rotor rotational field can move in this case in the direction of rotation of the rotor and also against the direction of rotation of the rotor.

Further features and advantages are to be found in the description given below of the enclosed figures. In the figures the same reference characters refer to the same features and functions. The exemplary embodiments merely serve to explain the invention and are not intended to restrict ft.

In the figures:

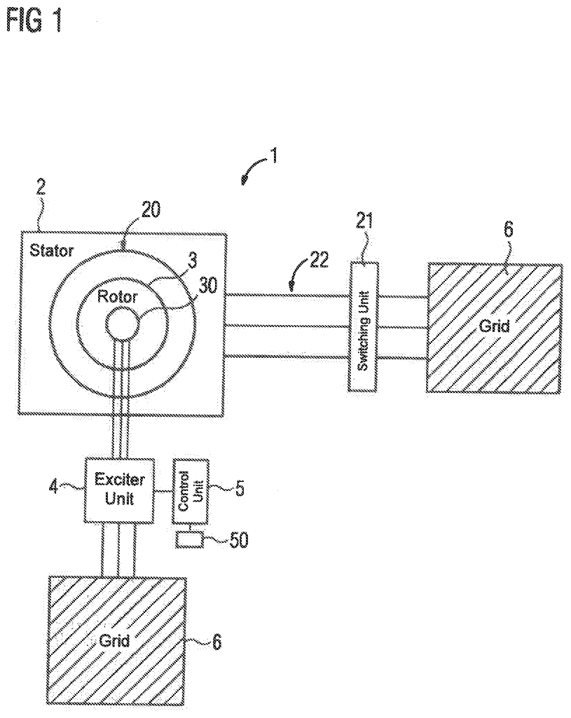

FIG. 1 shows a block diagram of a double-fed asynchronous machine, which is connected to an electrical grid;

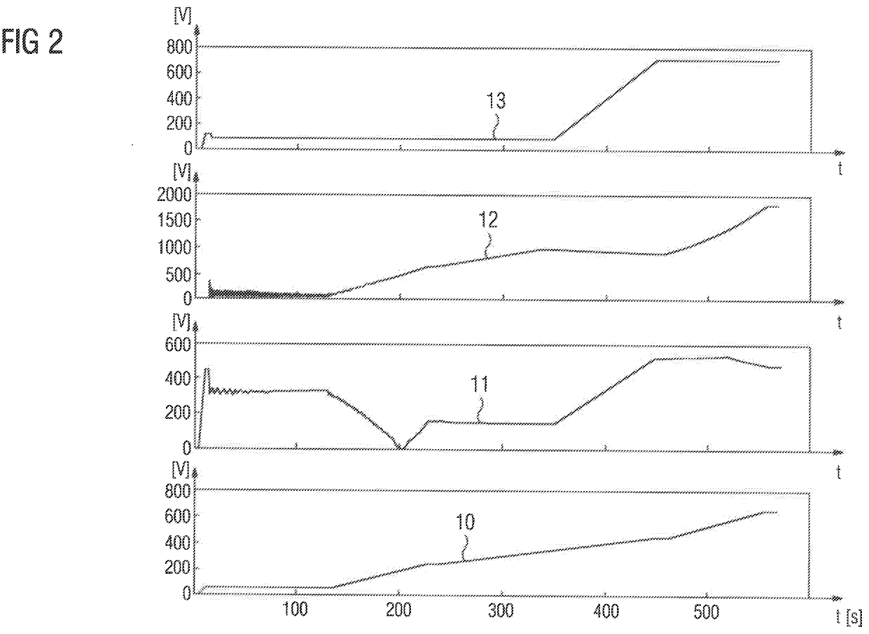

FIG. 2 shows the course of electrical variables related to the rotor and to the stator during a start-up process of the asynchronous machine;

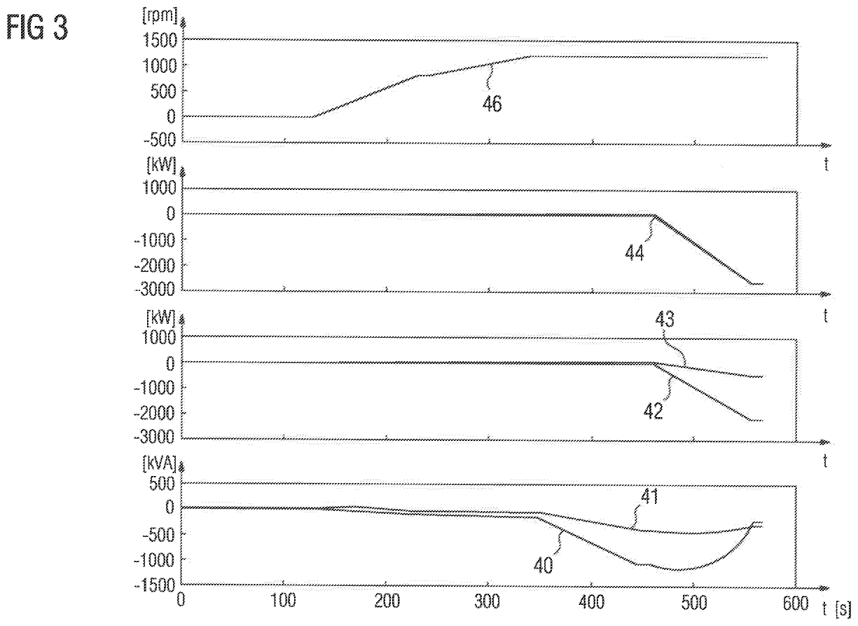

FIG. 3 shows the course of further electrical variables related to the rotor and to the stator during a start-up process of the asynchronous machine;

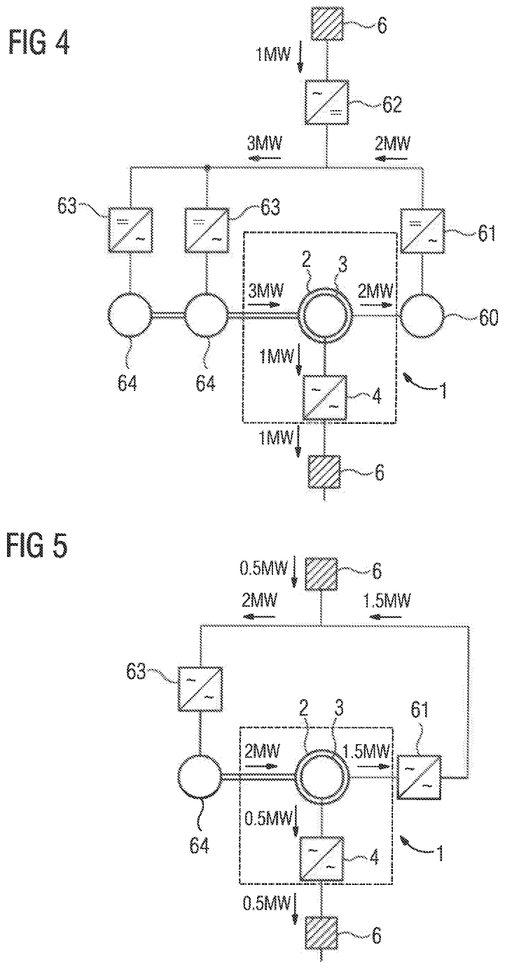

FIG. 4 shows a block diagram of a possible arrangement of the asynchronous machine; and

FIG. 5 shows a further block diagram of a possible arrangement of the asynchronous machine.

FIG. 1 shows a block diagram of a double-fed asynchronous machine 1, which comprises a stator 2, a rotor 3, an exciter unit 4 and also a control unit 5. An exciter winding 30 of the rotor 3 is able to be connected to an electrical grid 6 via the exciter unit 4. A winding arrangement 20 (only shown extremely schematically in the figure) is able to be connected to the electrical grid 6 via a switching unit 21. In this case the winding arrangement 20 is designed in particular as a three-phase arrangement, for which reason a connection has three phase legs. The switching unit 21 can be a part of the asynchronous machine 1. The electrical connection 22 between the stator 2 and the electrical grid 6 is able to be switched by means of the switching unit 21. In particular the electrical connection 22 is able to be disconnected by the switching unit 21.

The rotor 3 or the asynchronous machine 1 is able to be excited via the exciter winding 30 of the rotor 3. In this case the excitation occurs via the exciter unit 4. The excitation is controlled by the control unit 5, which predetermines at least one electrical variable for the excitation. The control unit 5 can comprise a memory unit 50, in which pre-specified criteria for adjusting the at least one electrical variable are able to be stored. For example a characteristic field for the at least one electrical variable is stored in the memory unit 50.

The at least one electrical variable, which is adjusted for the excitation, relates in particular to a frequency and an amplitude of a current flow (rotor current) or of a voltage (rotor voltage) in the exciter winding 30. In other words preferably at least two electrical variables are adjusted for the excitation. By adjusting the at least one electrical variable the excitation of the asynchronous machine 1 or of the rotor 3 can be controlled.

The exciter unit 4 in the present case is designed as a current converter, in particular as an inverter. Via the exciter unit 4, the rotor current and/or the rotor voltage of the exciter winding 30 are controlled and regulated in such a way that the rotor current or the rotor voltage correspond to the at least one electrical variable that is adjusted by the control unit 5. For example the exciter unit 4 has one or more switching elements that are controlled by the control unit 5. The switching elements in particular involve transistors, preferably field effect transistors, or IGBTs (bipolar transistor with insulated gate electrode).

Depending on the operating mode of the asynchronous machine 1, electrical power can be fed by the exciter winding 30 into the electrical grid 6 or by the electrical grid 6 into the exciter winding 30 via the exciter unit 4.

The excitation of the asynchronous machine 1 or of the rotor 3 is controlled by the control unit 5 completely independently of electrical stator variables of the stator 2. Examples of stator variables are stator currents or stator voltages for example. Stator currents and stator voltages are for example individual phase currents of the individual phases of the winding arrangement 20 as well as an overall current or an overall voltage resulting therefrom. Further examples of stator variables are the speed of rotation of the rotor 3 in relation to the stator 2 and also an angle of the rotor 3 in relation to the stator 2, This involves variables that are measured by a rotary position transducer of the stator in the prior art for example.

The excitation of the rotor 3 or the at least one electrical variable is controlled here in the sense of an open regulation circuit. Therefore interaction between the stator 2 and the exciter unit 4 as well as the control unit 5 can be dispensed with. Different values for the at least one physical variable can be predetermined in the characteristic field for a number of operating points or operating states of the asynchronous machine 1. The rotor voltage or the rotor current is thus controlled independently of the stator-related variables.

Because of the absence of interaction with the stator 2 the exciter unit 4 can be designed as a universally applicable current converter. In particular no special adaptation of the exciter unit 4 to the asynchronous machine 1 is necessary. The excitation of the asynchronous machine 1 is adapted exclusively here by the control unit 5.

In particular the stator 2 or the winding arrangement 20, in normal operation of the asynchronous machine 1, is connected directly, meaning in an unregulated way, to the electrical grid 6. This means that the switching unit 21 establishes a direct electrical connection 22 of the phase legs to the electrical grid 6. If the electrical grid involves the general 50 Hz interconnected grid, then the grid voltage of the electrical grid 6 is fixed and cannot be changed by the operation of the asynchronous machine 1 as electric motor or as generator. Therefore in this case the electrical grid 6 involves a voltage source. For this case it has proved advantageous to control the excitation of the rotor 3 with guided current. In other words the at least one electrical variable for the rotor current is predetermined. The exciter unit 4 represents a current source in this case.

In general it is possible for both the winding arrangement 20 and also the exciter winding 30 to each be connected to a current source or to a voltage source. It has proved advantageous however for the winding arrangement 20 to be connected to a current source and the exciter winding 30 to a voltage source or conversely for the winding arrangement 20 to be connected to a voltage source and the exciter winding 30 to a current source, Since the stator 2 is preferably connected statically to the electrical grid 6, which often represents a voltage source, it has proved advantageous to designed the exciter unit 4 as a current source.

Advantageously the rotor 3 or a shaft, which is part of the rotor 3 or is connected to the rotor 3, has a torsional vibration damper. The torsional vibration damper has a moment of inertia, which for example amounts to 10% of the rotor 3. The moment of inertia of the torsional vibration damper can be supported sprung on the shaft. In particular the moment of inertia of the torsional vibration damper is linked to the shaft in an elastic and damped manner. As an alternative or in addition a fan wheel can be arranged on the shaft.

FIG. 2 shows a number of stator-related and rotor-related electrical variables represented on a time scale t (in seconds). FIG. 2 shows the following: The rotor current 10, the rotor voltage 11, the stator current 12 and the stator voltage 13. In this case the four variables are each shown in volts (v). In this figure the asynchronous machine is at a standstill at a time t of 0 s. Thus FIG. 2 shows a start-up process of the asynchronous machine 1. The start-up process of the asynchronous machine 1 is especially important in the present method for controlling the excitation, since the fields of stator 2 and rotor 3 initially usually do not coincide. This means that the phase position between stator 2 and rotor 3 is initially undefined. It is first necessary to align the fields of stator 2 and rotor 3 in relation to one another.

To do this, in accordance with FIG. 2, the rotor 3 is first operated with a rotor current 10 of which the amplitude is less than a pre-specified start-up limit value. The start-up limit value is less by a pre-specified amount than a pre-specified operating value to which the amplitude of the rotor current 10 is adjusted in a normal mode of operation, for example at rated power, of the asynchronous machine 1. By injecting the rotor current 10 into the exciter winding 30, a rotor voltage 11 is produced at the exciter winding 30. The frequency of the rotor current 10 is fixed at the grid frequency of the electrical grid 6. The stator 2 or the winding arrangement 20 is initially still disconnected from the electrical grid 6.

The stator 2 or the winding arrangement 20 is connected to the electrical grid 6. This takes place for example by closing respective switches of the switch unit 21.

This produces a compensation process, in which flow in the winding arrangement currents 20 and generate a torque at the rotor 3, so that the rotor 3 aligns in the field of the stator 2. Through this the phase position between the stator 2 and the rotor 3 is adjusted appropriately. In particular the chosen pre-specified limit value is sufficiently small for the compensation currents not to exceed a pre-specified amount.

With the asynchronous machine 1 it is possible to change the speed of rotation. In other words the asynchronous machine 1 offers the option of regulating the speed. This is done in particular through a continuous change of the frequencies of stator 2 or of rotor 3. In particular the frequencies of the stator current and/or of the stator voltage or the frequencies of the rotor current and/or of the rotor voltage are changed continuously in order to change the speed of rotation. By continuously changing the frequencies, the synchronism between stator 2 and rotor 3 is not lost. As well as the frequency of the rotor current and/or rotor voltage (rotational frequency), the direction of rotation of the rotor rotary field can also be changed, so that any given speed of rotation of the rotor can be reached. As an alternative or in addition the amplitude of the rotor current or of the rotor voltage can be changed, in order to control the active power and also the reactive power of the asynchronous machine 1. For example, by predetermining a pre-specified value for the amplitude of the rotor current or of the rotor voltage, the active power and/or the reactive power of the asynchronous machine can be adjusted to a further pre-specified value.

FIG. 3 shows the same start-up process of the asynchronous machine 1, wherein other values are plotted on the same time axis t (in seconds: Electrical reactive power of the rotor 40 (in kVA), electrical reactive power of the stator 41 (in kVA), electrical active power of the rotor 42 (in kW), electrical active power of the stator 43 (in kW), mechanical power of the asynchronous machine (in kW) and also speed of rotation of the rotor 46 (in revolutions per minute, rpm).

FIG. 4 and FIG. 5 each show an arrangement with the asynchronous machine 1, These figures can involve test rigs for the asynchronous machine 1. For example the characteristic field for the asynchronous machine can be created on the test rig.

In FIG. 4 the asynchronous machine 1 is shown in a test environment or on a test rig. Here the asynchronous machine 1 is operating in generator mode, in the present example the asynchronous machine 1 is driven mechanically via two load machines 64. Electrical energy is fed from the rotor 3 of the asynchronous machine 1 into the electrical grid 6, Moreover electrical energy is fed from the stator 2 of the asynchronous machine 1 into a synchronous machine 60, The two load machines 64 are controlled by respective inverters 63. The inverters 63 in their turn are supplied with an electrical voltage via voltage-regulated inverters 61, 62. The exciter unit 4 is embodied in this example as a current-regulated inverter, Electrical and mechanical energy flows are to be taken from FIG. 4.

FIG. 5 shows the asynchronous machine 1 in another test setup. Here too the exciter unit 4 is embodied as a current-regulated inverter. The electrical power from the stator 2 of the asynchronous machine 1 is fed directly to the current-regulated inverter 61 here. In the example of FIG. 5, the test setup has only one load machine 64, which is controlled via the inverter 63,

What is claimed:

1. (canceled)

2. A method for operating a double-fed asynchronous machine, comprising:
exciting an exciter winding of a rotor of the asynchronous machine by adjusting at least one electrical variable independently of armature values of a winding arrangement of a stator of the asynchronous machine so as to attain a predetermined phase position and a predetermined amplitude in the stator, wherein the at least one electrical variable comprises an amplitude and/or a frequency of a voltage or of a current flow of the rotor;
during a start-up process of the asynchronous machine and while the exciter winding is adjusted and while a winding arrangement of the stator is disconnected from an electrical grid;
increasing a speed of rotation of the rotor,
adjusting the amplitude of the voltage and/or of the current flow to less than a predetermined start-up limit value, and
adjusting the frequency of the voltage and/or of the current flow to a grid frequency of the electrical grid;
thereafter connecting the winding arrangement to the electrical grid; and
adjusting the amplitude of the voltage and/or of the current flow to a predetermined operating value which is greater than the predetermined start-up limit value by at least a predetermined amount.
